(19) United States
(12) Patent Application Publication
(10) Pub. No.: US 2007/0245766 A1
(43) Pub. Date: Oct. 25, 2007

(54) In-line beverage chilling apparatus

(76) Inventors: Matthew C. Younkle, Chicago, IL (US); Kristofer Dressler, Chicago, IL (US)

Correspondence Address: BRINKS HOFER GILSON & LIONE, P.O. BOX 10395, CHICAGO, IL, 60610, US

(21) Appl. No.: 11/784,133

(22) Filed: Apr. 5, 2007

Related U.S. Application Data
(60) Provisional application No. 60/789,643, filed on Apr. 5, 2006.

(51) Int. Cl. B67D 5/62

(52) U.S. Cl. 62/393; 62/389; 62/398

(57) ABSTRACT

An apparatus for cooling a beverage, including a beverage conduit encased within a thermally conductive body, which is placed in contact with a cooling medium, where substantially all of the surface area of the conduit is in contact with the thermally conductive body, and a cooling medium and substantially all of the surface of the thermally conductive body is in contact with the cooling medium when the apparatus is in its intended operating position. The apparatus may cool at beverage traveling through conduit from a storage temperature to a serving temperature.

Applicants claim priority to U.S. Provisional Patent Application Ser. No. 60/789,643, filed on Apr. 5, 2006, the entire contents of which are incorporated herein by reference.

The present invention relates to an apparatus for cooling beverages as they are served. More specifically, the present invention relates to an apparatus for use in-line with a beverage dispensing system that can cool a beverage to a desired temperature while the beverage is being dispensed at a high volumetric flow rate.

### BACKGROUND OF THE INVENTION

Carbonated beverages, especially soda and beer, are generally served cold. The two reasons for serving them cold are to increase the perception of refreshment to the consumer and to ease the dispensing of the beverage. Many carbonated beverages, especially beer, are stored in stainless steel containers and dispensed through a series of tubes that carry the beer to the beer dispensing faucet at the dispensing point. More specifically, beer is often stored in 15.5 gallon stainless steel kegs. When possible, the entire keg is kept at the appropriate temperature for serving. Vendors of these beverages use a variety of methods to cool the beverage before it is served. Under some circumstances, the keg is stored at a temperature above the optimal temperature for serving.

One method of cooling a beverage for consumption is to present a single serving in a container with a cold media, typically ice. Ice is a very effective way to cool beverages because of the thermodynamic properties of frozen water. In order for one gram of ice to increase one degree Centigrade, it must absorb 4.18 Joules of energy from its surroundings. Once the ice has reached its melting point, each gram of ice must absorb an additional 334 Joules of energy in order to undergo the transformation from the solid phase to the liquid phase. The same effect can be achieved by using any media that undergoes a phase change as it warms. This is a very effective way to cool a beverage as long as the liquid water generated by the ice mixing with the beverage is deemed acceptable to the consumer. However, with some carbonated beverages, such as beer, adding ice to the beer is not an acceptable method for cooling the beer, as it results in watering down the beer.

The cooling properties of water and ice are also used in two other techniques for cooling beverages: The cold plate (FIG. 2) and the cold coil (FIG. 3.) The cold plate is a serpentine arrangement of metal beverage conduit (not shown), usually stainless steel, encased within a flat plate of aluminum. U.S. Pat. Nos. 4,888,961 and 4,291,546 are illustrative of basic cold plate technology. The plate is placed in the bottom of a container. Ice is placed into the container and on top of the cold plate. The heat from the liquid in the tubing is conducted away from the tubing by the aluminum to the ice above. Typically, the plate is elevated so that liquid water is able to run off the plate so that the plate remains in contact with the ice. Most cold plate technology is designed for soda. The plates are designed to chill flavored syrups and carbonated water and to easily fit within the ice chest integrated with soda dispensing machines.

When the ice is exposed to the warmer plate, it melts. The temperature of the plate near the center of the cold plate is typically higher than it is near the edges due to the higher ratio of warm liquid to surface area available for cooling. Thus, the ice in contact with the center of the plate melts faster and the resulting liquid then runs off, leaving the cold plate relatively ineffective in the central region. This phenomenon is often referred to as “bridging” by those in the beverage industry. Bridging greatly reduces the effectiveness of the cold plate.

The second known way of cooling beverages, as shown in FIG. 3 the cold coil, is simply a coil of beverage tubing, usually stainless steel that has been placed in a bath of ice and water with its central axis X vertically oriented. The cold coil provides more surface area to contact the ice bath than the cold plate since the coil itself is immersed in a cold liquid. The coil is often a single helix or double helixes that share the same central axis.

With previous coils, as shown in FIGS. 4A and 4B, to achieve the greatest length of tubing in the smallest volume, the pitch of the coil was about equal to one diameter of the tubing, causing the tubes in a given revolution to be in physical contact with the next revolution. Because water is a very poor conductor of heat, around 0.6 Watts/meter-degree Kelvin, the water surrounding the portions of the tubing in contact with other portions of the tubing heat up quickly and hence lose cooling effect on the beverage.

The temperature of a carbonated beverage is closely related to the pressure under which it is stored. With carbonated beverages, the partial pressure of the dissolved carbon dioxide, the solute, varies with the temperature of the beverage, the solvent. In order to maintain the desired level of carbonation, the pressure of the applied carbon dioxide must be varied according to the temperature of the beverage.

In-line cooling devices, such as cold plates and cold coils, are typically used in situations where the beverage is not stored at ideal serving temperatures. In order to keep the dissolved gas in solution, higher than normal pressures must be applied. To counter-act these pressures, known in-line cooling devices use a long length of tubing having a small internal diameter, which result in a very large head loss as the beverage flows. This head loss is large enough such that equilibrium between the high keg (storage container) pressure and atmospheric pressure is reached at a low flow rate, often less than 1 gal/minute (4.2 liters/minute). In high volume concession environments, the low flow rate is very inconvenient and inefficient, causing long wait lines for beverages and potential loss or reduction in sales.

Thus, there is a need for a more effective system of cooling beverages in in-line dispensing systems without sacrificing flow rate.

### SUMMARY OF THE INVENTION

The present invention relates to an apparatus for cooling beverages as they are served. More specifically, the present invention relates to an apparatus that is installed in-line with a beverage dispensing system that can effectively cool the beverage to a desired temperature while the beverage is being dispensed at a high volumetric flow rate. The apparatus may include a beverage conduit encased within a thermally conductive body, and a cooling medium. In operation, substantially all of the surface area of the conduit is in contact with the thermally conductive body and substantially the entire surface of the thermally conductive body is in contact with the cooling medium. The apparatus may cool at beverage traveling through conduit from a temperature of about 70° F. to a temperature of about 38° F., with a steady-state throughput of beverage through the conduit of about 1.0 gallons or greater of beverage per minute.

### BRIEF DESCRIPTION OF THE DRAWINGS

FIG. 1 depicts a short draw draft beer dispensing system.

FIG. 2 depicts a beverage cooling cold plate.

FIG. 3 depicts a beverage cooling coil.

FIG. 4A shows a helical coil in which the pitch of the helix is equal to the diameter of the tubing.

FIG. 4B is a section view of the coil in FIG. 4A, showing the relative positioning of adjacent turns of a helical coil beverage conduit.

FIG. 5 is a cutaway view for a possible serpentine configuration of the beverage conduit within a conductive body.

FIG. 6 is a cutaway view for a possible helical configuration of the beverage conduit within a conductive body.

FIG. 7 is a perspective view of a helical configuration of beverage conduit with substantial spacing between consecutive revolutions of the coil.

FIG. 8 depicts an example of a thermally conductive body for use with the beverage cooling apparatus.

FIG. 9A depicts a perspective view of a thermally conductive body for use with the beverage cooling apparatus.

FIG. 9B depicts another perspective view of a thermally conductive body for use with the beverage cooling apparatus.

FIG. 10A is a perspective view of an alternative geometry for a conductive body.

FIG. 10B is a top view of the conductive body depicted in FIG. 10A.

FIG. 10C is a perspective view of another alternative geometry for the conductive body.

FIG. 10D is a top view of the conductive body depicted in FIG. 10C.

FIG. 11 is a top view of a conductive body with projections on both its inner and outer surfaces showing a top-to-bottom taper of said projections.

FIG. 12A is a side view of a possible non-toroidal example of a thermally conductive body.

FIG. 12B is a perspective view of the thermally conductive body of FIG. 12A.

FIG. 12C is another side projection of the thermally conductive body of FIG. 12A.

FIG. 12D is a top view of the thermally conductive body of FIG. 12A.

FIG. 13 is a section view of an example of a thermally conductive body, without the projections, illustrating the taper of the body from bottom to top.

FIG. 14 is a section view of another example illustrating a beverage conduit configured in a double helix with spacing between consecutive revolutions of each helix.

FIG. 15A is a side view of a beverage conduit configured as a single helix with spacing between consecutive revolutions of the coil.

FIG. 15B is a section view of the beverage conduit of FIG. 15A.

FIG. 16 is a cross-sectional view depicting the heat flow from the beverage conduit through the thermally conductive body in the situation of little or no spacing between consecutive revolutions of the helical beverage conduit.

FIG. 17 is a cross-sectional view depicting the heat flow from the beverage conduit through the thermally conductive body in the situation of substantial spacing between consecutive revolutions of the helical beverage conduit.

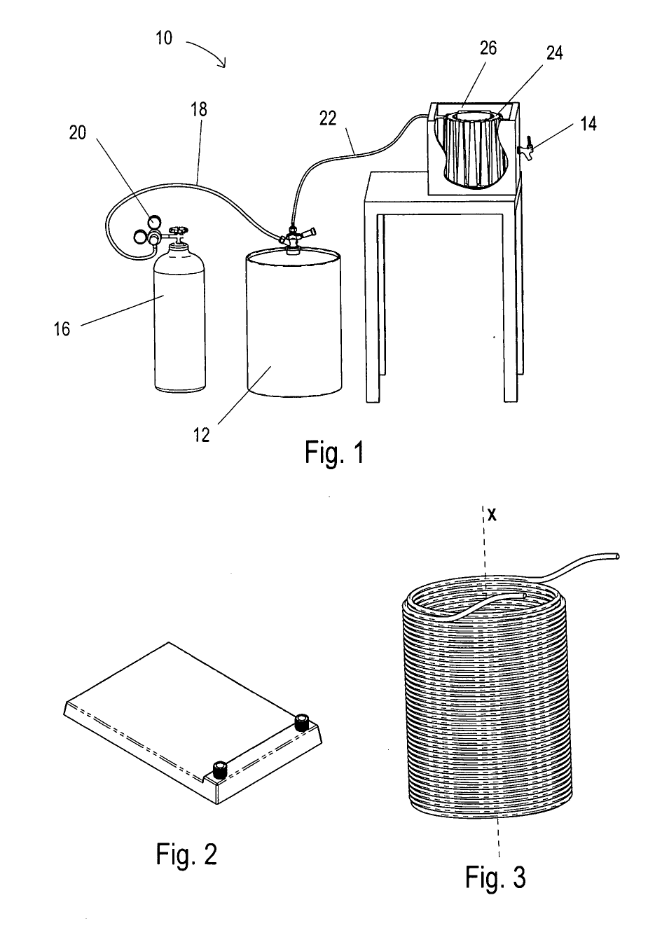

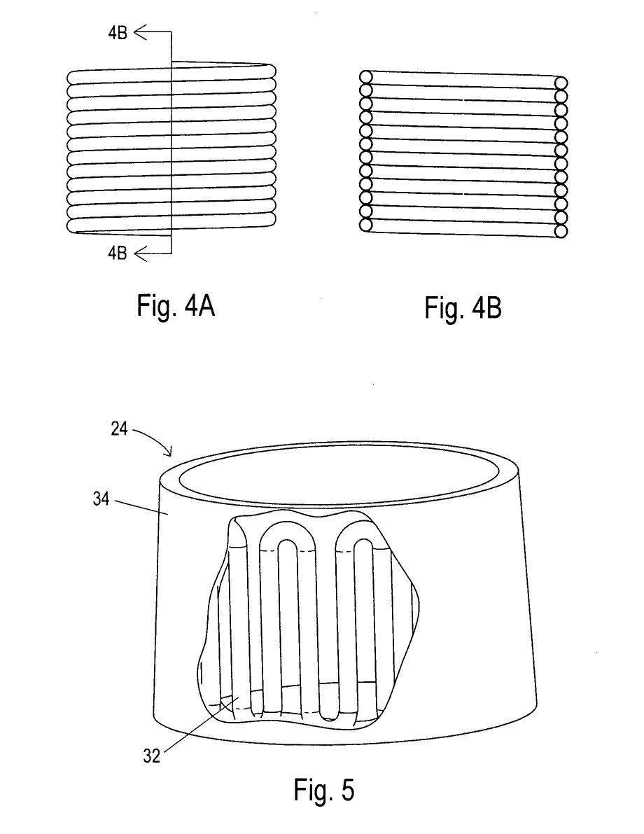

### DETAILED DESCRIPTION

An in-line beverage dispensing system 10, for dispensing a carbonated beverage such as beer, is shown in FIG. 1. Beer contained in a storage container, such as a beer keg 12, requires an energy source for conveying the beverage from the beer keg 12 through the dispensing system 10 to a beer faucet 14. The driving force that causes the flow of beer is typically a pressure differential between the high pressure in the storage container and ambient atmospheric pressure. The pressure in the storage container 12 is often achieved by introducing pressurized gas, for example carbon dioxide or a blend of carbon dioxide and another gas, preferably Nitrogen, into the storage container. The gas is stored in a separate container and the pressure at which it is released to the beverage storage container is regulated by a pressure regulating device. In such systems, a tank 16 containing pressurized CO₂ is connected to the beer keg 12 via a pressurized gas hose 18. A pressure regulating device 20 serves as a means to adjust the pressure of the CO₂ driving the beer through the system 10. Beer is moved from the keg 12 through tubing 22 to an in-line beverage cooling apparatus 24, including cooling conduit (not shown in FIG. 1), which has been placed in a cooling unit 26, which contains a cooling media, typically ice, water or a combination of ice and water. Exposure of the beverage cooling apparatus to the cooling media functions to reduce the temperature of the beer flowing through the cooling conduit.

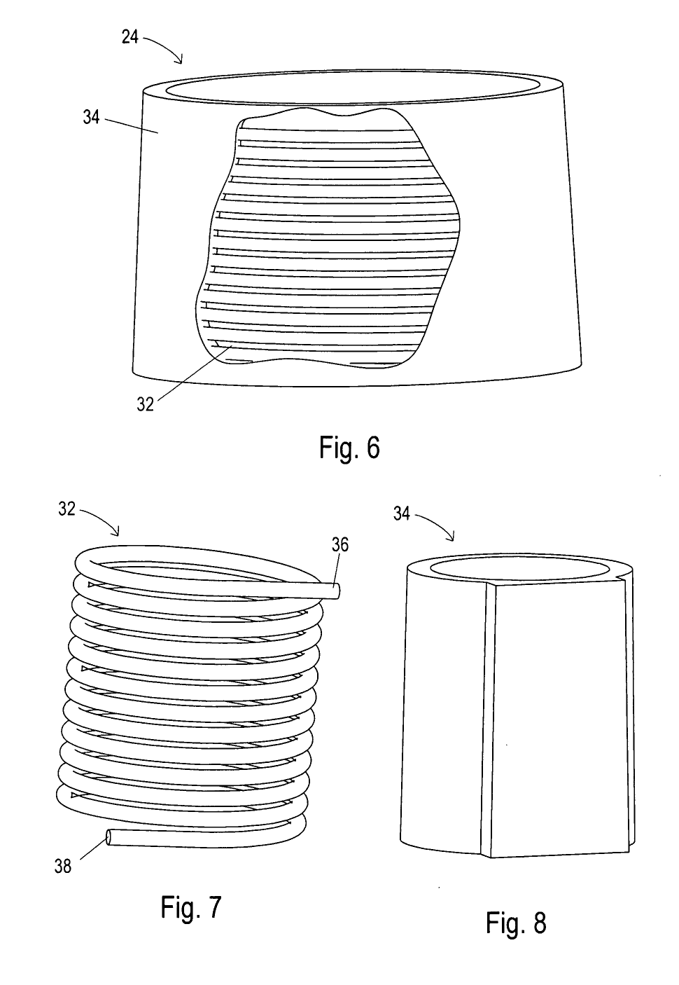

As shown in FIGS. 5 and 6, the beverage cooling apparatus 24 includes a length of beverage cooling conduit 32 encased within a body 34 of thermally conductive material. The beverage cooling apparatus 24 may have a geometry such that substantially the entire surface of the conduit is exposed to the thermally conductive material, and thus exposed to the cooling media.

As shown in FIG. 7, the beverage conduit 32 may be in the shape of a helical coil although the configuration may take other forms. In one example, as shown in FIG. 5, the coil of the beverage conduit 32 may have a generally sinusoidal configuration.

A helical coil conduit 32 may be constructed by winding a straight section of stainless steel tubing around a drum. Stainless steel tubing is one material that may be used when working with beverages, especially beer, due to its non-corrosive nature. However the conduit also may be made from copper, brass, silver, titanium or any other material provided the melting point of the conduit material is higher than the melting point of the material from which the thermally conductive body 34 is formed.

The conduit 32 may be wound such that there is some spacing between adjacent turns of the coil. The spacing between the revolutions of tubing may be achieved by moving the drum or moving the source of the straight tubing. In one example, the spacing between consecutive revolutions of the helix will be equal to the radius of the conduit 32 itself. The diameter of the conduit may be between about 6 mm and about 25 mm. For example, the diameter of the conduit may be between about 8 mm and about 20 mm. Further, the diameter of the conduit may be between 10 mm and about 14 mm. The tubing may be trimmed after the coil is completed in order to leave the tangential inlet and outlet tubes for use in the casting process.

The shape of the conduit 32 is not limited to a helical coil. The arrangement of the beverage conduit 32 may be serpentine, serpentine-like, or double helical as it is routed within the thermally conductive body 34. For example, as shown in FIG. 5, the conduit 32 may include vertically oriented undulating or serpentine bends of tubing. In addition, the beverage conduit 32 also need not have a circular cross section. For example, the cross-section may be oval, square, triangular, or any other configuration.

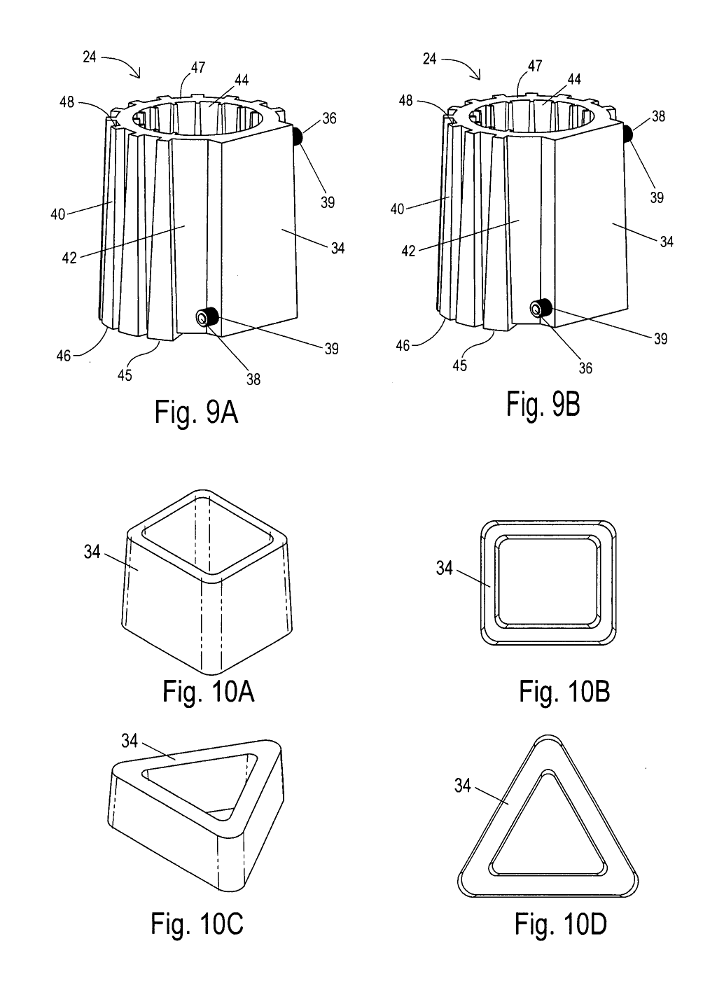

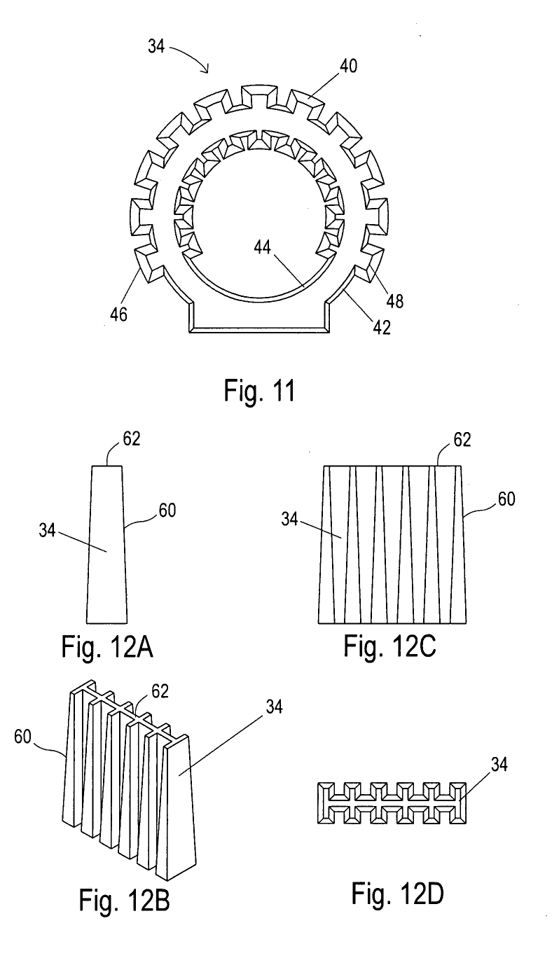

As shown in FIGS. 5, 6, 8 and 9A-B, the thermally conductive body 34 may be a cylindrical or toroidal body having an outward facing surface 42 and an inward facing surface 44. As shown in FIGS. 7 and 9A-B, the conduit 32 has an inlet 36 and an outlet 38 where threaded fittings 39 may be used to attach standard beverage tubing. To encase the conduit 32 in the thermally conductive body 34, the conduit 32 may be placed in a sand core mold and held in place by fixtures holding the inlet and outlet tubes. The core mold may be an open mold into which, for example, molten aluminum is poured from above. The molten aluminum is kept at a temperature sufficient to allow it to flow freely to the bottom of the mold without overheating, for example from about 1250° F. to about 1350° F. As a result the entire outside surface area of conduit 32 is in contact with thermally conductive material.

The geometry of the thermally conductive body 34 maximizes the surface area exposed to the cooling media. For example, a toroidal shape (as shown in FIGS. 5, 6, 8, 9A-B, and 11), allows over about 90% of the total surface area to be exposed to the cooling media. If the cooling media is ice, when some of the ice melts and forms ice water in the bottom of the container in which the thermally conductive body 34 is placed, the surface area of the thermally conductive body 34 exposed to the cooling media may be virtually 100%.

Generally speaking, for a given material, the more massive the thermally conductive body 34, the greater its capacity for cooling the beverage. Portability of this invention, however, is a highly desirable characteristic that places practical constraints on the mass of the body 34. Additionally, this device desirably fits within a readily available thermally insulated container. Accordingly, the mass of the thermally conductive body 34 may be between about 5 kg and about 30 kg. In one example, the mass of the thermally conductive body 34 may be between about 10 kg and about 20 kg. Further, the mass of the thermally conductive body 34 may be between about 12 kg and about 16 kg. The height of the thermally conductive body 34 may be between about 10 cm and about 60 cm. For example, the height of the thermally conductive body 34 may be between about 20 cm and about 40 cm. Further, the height of the thermally conductive body 34 may be between about 25 cm and about 32 cm. For a toroidal configuration, the diameter of the thermally conductive body 34 may be between about 10 cm and about 60 cm. For example, the diameter of the thermally conductive body 34 may be between about 20 cm and about 40 cm. Further, the diameter of the thermally conductive body 34 may be between about 25 cm and about 32 cm.

As shown in FIGS. 9A-B and 11 (in perspective and top views, respectively), the thermally conductive body 34 may be provided with projections 40 on the outward facing surface 42 and, if present, the inward facing surface 44 of the thermally conductive body 34 to increase the surface area exposed to the cooling media. The projections may be fins, wedges, blocks, rings, or any other geometry that increases the surface area of the thermally conductive component of the apparatus.

The projections 40 may be tapered such that they are circumferentially wider near their bottom 46 and narrower near their top 48. The projections 40 may be arranged in such a way that as a piece of ice or other cooling media is reduced in size due to melting, and is drawn toward the bottom by gravity, it remains in contact with the thermally conductive body 34. This is to counter the “bridging” effect experienced with known cooling devices.

Although the apparatus has been described here as having a toroidal shape, the shape of the apparatus may be of other geometries, for example the shapes illustrated in FIGS. 12A-D. As shown, the body 34 may be constructed to have a repeating H-shape, which may be broader at its base. As shown, the longitudinal dimension or surface 60 has a greater area than the lateral dimension or surface 62. In this configuration, the conduit 32 may be configured in vertical or horizontal undulations or bends throughout the interior of the body 34.

As shown, for example in FIG. 9A, the beverage inlet 36 is positioned at the top of the apparatus with the outlet 38 at the bottom. When the beverage is warm, the temperature differential between the beverage and the ice is the greatest. Since the heat transfer is a function of the temperature differential, the heat transfer and the subsequent melting of ice will be the greatest near the top. As the beverage flows towards the bottom of the device, it is cooler and will experience less heat transfer. To counter this effect, the bottom of the thermally conductive body may be thicker to serve as a greater heat sink. Alternatively, as shown in FIG. 9B, the beverage inlet 36 is positioned at the bottom of the apparatus with the outlet 38 at the top.

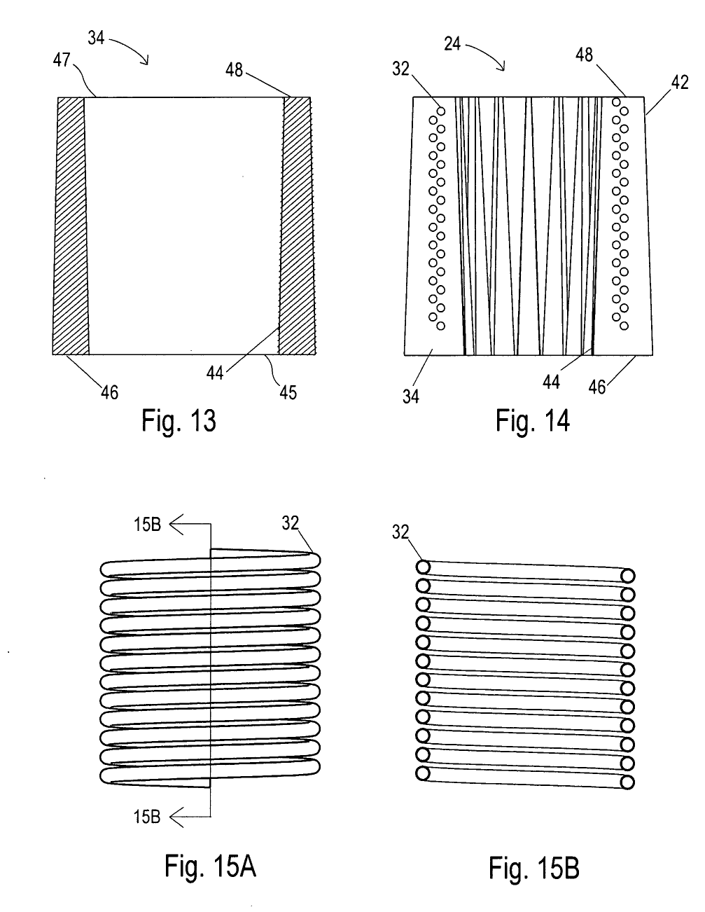

As shown in FIGS. 13 and 14, the thermally conductive body 34 may be tapered. This assists in maintaining optimal contact of the surface of the component with cooling media. For example, the thickness of the body 34 may be greater at its base 45 than at its top 47, thus forming a taper. This taper, with the thickest section at the bottom, uses the downward force of gravity and the melting of the ice to keep more of the ice in contact with the thermally conductive body 34. The thickness of the base 45 of the body 34 may be between about 10 mm and about 120 mm. For example, the thickness of the base 45 of the body 34 may be between about 20 mm and about 75 mm. Further, the thickness of the base 45 of the body 34 may be between about 30 mm and about 50 mm.

The maximum angle of taper is limited by the thickness of the base 46 and the target height of the thermally conductive body 34. The total angle of taper between the outer 42 and inner 44 surfaces of the thermally conductive body may be between about 0.5 and 90 degrees. For example, the total angle of taper may be between about 2 and about 45 degrees. Further, the total angle of taper may be between about 3 and about 15 degrees. For example, a tapered toroidal shape ensures that gravity will keep an inverted frustum of ice cubes in contact with the inward facing surface 44 of the body 34 at all times. The reverse is true on the outer surface 42. Gravity continually draws the melting ice downward and the body 34 itself is the frustum being wedged into the ice. As shown FIGS. 13 and 14, the interior 44 of the body 34 may also form a taper, with the interior of the body 34 narrowing from top to bottom.

Because warm beverages are poured, then stopped, then poured again, ice near the top of the device will melt the fastest upon introduction of warm beverage, where as the thermally conductive material absorbs most of the heat from the beverage as it flows through the lower portion. When the flow of beverage is stopped, the ice from around the lower portion absorbs the heat from the thermally conductive material. Ultimately, the rate of ice melting as the flow of beverage is repeatedly started and stopped is fairly uniform. This keeps the amount of ice in contact with the thermally conductive solid at a maximum.

The thermally conductive body 34 may be constructed of aluminum, copper, brass, silver or any other thermally conductive material having thermal conductivity, k, of about 50 W/m° C. or greater. For example, the material may have a k-value of about 100 W/m° C. or greater. In another example, the k-value of the material may be about 200 W/m° C. or greater.

The thermally conductive material makes any number of beverage conduits more effective at cooling the beverage than the conduit would be by itself. For example, the principal behind the existing cold plate technology is to cool a block of thermally conductive material, which in turn cools the walls of the passage which in turn cools the beverage. The heat transfer rate, or cooling, is a function of surface area. All existing cold plates are arranged such that the cooling media, in most cases, ice, is only applied to one surface of the cold plate, less than half of the available surface area. Previous beverage cooling coils included multiple layers of closely packed tubing with a smaller diameter in an attempt to maximize surface area of tubing exposed to a cooling media. However, the small diameter of the tubing restricted the flow rate of the beverage through the tubing, and the close packing of the coils limited available cooling surface area.

The beverage cooling apparatus 24 may incorporate larger diameter conduits than conventional conduits. The use of larger diameter conduit has two advantages. First, it reduces the head loss of the beverage as it flows through the tubing. This enables a higher flow rate at the same keg pressure. For a given length of conduit 32, the second advantage is that the beverage will spend a longer period of time within the device. With the higher volume and a given volumetric flow rate, the beer remains in the device longer and has more time to cool. The time that the beverage remains within the thermally conductive solid 34, the resident time, may be calculated by the formula:

$$t = \frac{π {r}^{2} l}{Q}$$

where
t is the time within the conduit
r is the radius of the conduit
l is the length of the conduit
Q is the volumetric flow rate

At steady state, the warm beverage will be sufficiently cooled if it has about 7 seconds to cool within a thermally conductive body encasing the tubing. The beverage will have about a 9 second resident time or more within the thermally conductive body. For example, the beverage may have a resident time within the thermally conductive body 34 of about 11 seconds or more. For a given conduit radius, resident time, and volumetric flow rate, the length of the conduit can be determined. The length of the conduit 32 may be between about 4 and about 40 meters. For example, the length of the conduit 32 may be between about 5 and about 20 meters. Further, the length of the conduit 32 may be between about 6 and about 15 meters.

A flow rate of greater than about 1 gallon per minute at pressures ranging from about 14 psi (0.965 bar) to about 40 psi (2.76 bar) may be achieved with the beverage cooling apparatus 24 described. A flow rate of between about 1.5 and about 4 gallons per minute at pressure ranging from about 18 psi (1.25 bar) to about 28 psi (1.85 bar) further may be achieved.

In typical concession environments, two or three servings are dispensed, the faucet 14 is closed as the transaction is completed, and then the faucet 14 opens again to dispense the servings for the next transaction. The few seconds between dispenses allows multiple servings to be contained within the device during which additional cooling takes place.

The cooling apparatus 24 makes use of the basic principles of heat transfer. Heat transfer is a product of three quantities: thermal conductivity, surface area, and thermal gradient.

$$Q = - k A \frac{ⅆ T}{ⅆ x}$$

where
Q=heat transfer, the flow of heat away from the beverage
k=thermal conductivity, the ease with which heat flows through the solid
A=area, in the case, the area exposed to the cooling media
dT/dx=thermal gradient, the rate at which the temperature decreases as the distance in a given direction from the warm beverage increases.
   Because aluminum is the mostly commonly used thermally conductive material, the value for k will remain constant. A is essentially the area of the tubing 32 exposed to the thermally conductive solid 34. Smaller diameter tubing decreases the volume to surface area ratio. Using larger diameter tubing increases this ratio slightly, thereby decreasing efficiency. Because the beverage cooling apparatus 24 exposes both the inner 44 and outer 42 surfaces of the thermally conductive body 34 to the cooling medium, the quantity of A, and hence the heat transfer, are doubled.

When a helical coil is used as the conduit, the adjacent turns of the coil may be space from one another, as shown in FIGS. 7 and 15A-B. By spacing the tubing 32 slightly, the heat gradient increases. The temperature of the thermally conductive solid 34 as a function of distance from the warm tubing can be modeled roughly by
T=−cd²
Where
T=temperature of the solid
c=a constant, dependent on thermal conductivity, temperature difference, etc., and
d=distance from the tubing.

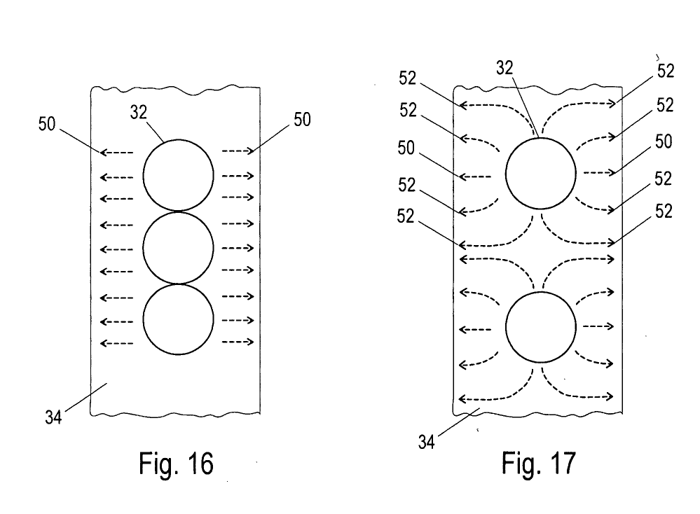

When two channels of conduit 32 run very close to each other, the heat conducting from the two tubes warms the thermally conductive material around them, thereby reducing the temperature gradient. Even a small separation of the tubing 32 greatly reduces the temperature of the thermally conductive material due to the quadratic nature of the temperature distribution function. With tubing 32 close together, the temperature between the tubes increases, decreasing the dT/dx. With a smaller dT/dx, the magnitude of q goes down. In other words, there is virtually no heat transfer in the axial direction when the tubing 32 is packed closely together, as illustrated in FIG. 16. The majority of the heat transfer happens in the radial direction, shown by arrows 50. By increasing the distance between adjacent parts of the conduit 32, as shown in FIG. 17, the heat flow in both axial (as shown by arrows 52) and radial directions 50 is increased.

High flow rate at a wide range of pressures may be achieved by the beverage cooling apparatus 24. The pressure loss as fluid flows through a channel is often referred to as “head loss” in the plumbing trade and “restriction” in the beer trade. Restriction is an important part of any draft beer system, and for the most part is managed with experience, trial and error, and some rough tables. Scientists studying fluid mechanics have modeled restriction, or more generally, pressure loss with the equation

$$Δ P = \frac{L f {Q}^{2} ρ}{4 {π}^{2} {r}^{5}}$$

Rearranged and solved for the Q, the flow rate, the equation becomes

$$Q = \sqrt{\frac{Δ P 4 {π}^{2} {r}^{5}}{L f ρ}}$$

Where
ΔP=total pressure loss
L=length of passage
f=friction factor of tubing material
Q=volumetric flow rate
ρ=density of fluid
r=radius of tubing

[image]

The plot of the flow rate, Q, as it varies with the change in pressure, ΔP, is parabolic in shape. Given the temperature range at which the beverage is stored, the concentration of carbon dioxide that is dissolved in the beverage, and the desired flow rate, it is a simple calculation to use the above mathematical model to design an apparatus that will maintain a consistent flow rate over a range of pressures necessary to maintain carbon dioxide equilibrium. Regardless of the pressure necessary to maintain proper carbonation, the flow rate stays within the capacity of the dispensing device.

When the flow of beverage through the device is regularly interrupted, the thermally conductive body 34 acts as a heat sink. The mass ratio of thermally conductive material to beverage combined with the specific heat capacities of the material defines the cooling capacity of the apparatus 24. When a certain mass of warm beverage, for example beer, is cooled by a certain mass of a thermally conductive solid, for example aluminum, although any material having the desired k-value may be used, the heat gained by the aluminum is equal to the heat lost by the beer.
ΔHₐₗᵤₘᵢₙᵤₘ=−ΔH_{beer}
The heat gained or lost by a material is defined by
ΔH=(m)(c)(ΔT)
where
m=the mass of the substance
c=the specific heat capacity of the substance
ΔT=the change in temperature of the substance
Substitution gives the equation for the specific case
   (mₐₗᵤₘᵢₙᵤₘ)(Cₐₗᵤₘᵢₙᵤₘ)(Tₛ−T₀)=(m_{beer})(c_{beer})(T_{w}−Tₛ)
   where
mₐₗᵤₘᵢₙᵤₘ=the mass of aluminum
cₐₗᵤₘᵢₙᵤₘ=the specific heat capacity of aluminum
Tₛ=the temperature at which the beer will be served
T₀=the initial temperature of the solid, (generally 0° C.)
m_{beer}=the mass of beer
c_{beer}=the specific heat capacity of beer
T_{w}=the temperature at which the warm beer enters the device
Solving for the mass ratio of aluminum to beer, the equation becomes

$$\frac{{m}_{aluminum}}{{m}_{beer}} = \frac{( {c}_{beer} ) ( {T}_{w} - {T}_{s} )}{( {c}_{aluminum} ) ( {T}_{s} - 0 )}$$

Using approximate values for the beer and aluminum,

$${c}_{beer} = 4.11 \frac{J}{g ° C .}$$

$${T}_{w} = 15.5 ° C . \\ {T}_{s} = 3.3 ° C . \\ {c}_{Al} = 0.9 \frac{J}{g ° C .}$$

the ratio becomes

$$\frac{{m}_{aluminum}}{{m}_{beer}} = 16.8$$

When conductive and convective heat transfer between the thermally conductive material and the cooling media are taken into account, the ratio will be slightly lower.

Generally speaking, for a given thermal conductivity, the more massive the thermally conductive body 34, the greater its capacity for cooling a beverage. Similarly, the longer the beverage conduit 32, the greater the amount of time the beverage will spend circulating within the device at a given flow rate, and the greater its capacity for cooling the beverage.

When in the apparatus 24 is in its operating position, substantially all of the outer surface area of the conduit 32 is in contact with the thermally conductive body 34 and substantially all of the surface of the thermally conductive body 34 is in contact with the cooling medium. The storage temperature of the beverage may be as high as 80° F. Typically, the storage temperature of a beverage is about 42° F. to 55° F. Preferably, the apparatus 24 may cool the beverage from its storage temperature to a temperature of about 45° F. or below. For example, the dispensing temperature of a beverage may be in the range of 32° F. to 45° F. In one example, such as in the United States, the brewery recommended serving temperature of a beer is about 38° F. The steady-state throughput of beverage through the conduit 32 may be about 1.0 gallons or greater of beverage per minute. For example, a flow rate of between about 1.5 and about 4 gallons per minute at pressure ranging from about 18 psi (1.25 bar) to about 28 psi (1.85 bar) further may be achieved.

It is therefore intended that the foregoing detailed description be regarded as illustrative rather than limiting, and that it be understood that it is the following claims, including all equivalents, that are intended to define the spirit and scope of the invention.

We claim:

1. An apparatus for cooling a beverage, comprising:
a thermally conductive body having a first surface and a second surface concentrically disposed within the first surface;
a beverage conduit, having a beverage inlet and a beverage outlet, encased within the body; and
a cooling medium in thermal contact with both the first surface and the second surface for cooling the thermally conductive body.

2. The apparatus of claim 1 where the apparatus operates to cool a beverage to a temperature of about 45° F. or lower with a steady-state throughput of beverage through the conduit of about 1.5 gallons or greater of beverage per minute at pressures between about 14 psi (0.965 bar) and about 40 psi (2.76 bar).

3. The apparatus of claim 1 where the beverage conduit comprises a vertical coil.

4. The apparatus of claim 3 where adjacent channel sections of the conduit are spaced from one another.

5. The apparatus of claim 4 where a channel section of the conduit is separated from an adjacent channel section by a distance of about the radius of the liquid conduit.

6. The apparatus of claim 1 where substantially all of the outer surface area of the conduit is in thermal contact with the thermally conductive body.

7. The apparatus of claim 1 where at least 90% of the surface area of the thermally conductive body is in thermal contact with the cooling media.

8. The apparatus of claim 1 where the second surface of the body tapers from top to bottom.

9. The apparatus of claim 1 where the first surface of the body tapers from bottom top.

10. The apparatus of claim 1 where the cross section of the thermally conductive body at a first end is smaller than the cross section of the thermally conductive body at a second end.

11. The apparatus of claim 1 where the thermally conductive body comprises at least one radial projection on one or both surfaces of the body.

12. The apparatus of claim 11, where the at least one projection is selected from the group consisting of fins, wedges, blocks, rings, or the like.

13. An apparatus for cooling a beverage, comprising:
a thermally conductive body configured for exposure to a cooling medium and having a longitudinally disposed surface, a laterally disposed surface, and at least one projection from the longitudinally disposed surface;
a beverage conduit, having an inlet and an outlet, encased within the body; and
where the area of the longitudinally disposed surface is greater than the area of the laterally disposed surface, substantially all of the surface area of the conduit is in thermal contact with the thermally conductive body, and substantially all of the surface of the thermally conductive body is in contact with the cooling medium when the apparatus is in its intended operating position.

14. The apparatus of claim 13 where the apparatus operates to cool a beverage to a temperature of about 45° F. or lower with a steady-state throughput of beverage through the conduit of about 1.5 gallons or greater of beverage per minute at pressures between about 14 psi (0.965 bar) and about 40 psi (2.76 bar).

15. The apparatus of claim 13 where at least 90% of the surface area of the thermally conductive body is in thermal contact with the cooling media.

16. The apparatus of claim 13 where the at least one projection is selected from the group consisting of fins, wedges, blocks, rings, or the like.

17. The apparatus of claim 13 where the beverage conduit comprises coil.

18. The apparatus of claim 13 where the cross section of the thermally conductive body at a first end is smaller than the cross section of the thermally conductive body at a second end.

19. The apparatus of claim 18 where the cross section of the thermally conductive body tapers from the first end to the second end.

20. A method of cooling a beverage comprising:
providing a cooling apparatus comprising a thermally conductive body having a first surface and a second surface concentric to the first surface, a beverage conduit encased within the body ,and a cooling medium, where substantially all of the outer surface area of the conduit is in contact with the thermally conductive body;
placing the cooling media in thermal contact with a surface of the thermally conductive body;
flowing beverage with a steady-state throughput of beverage through the conduit of about 1.0 gallon or greater of beverage per minute at pressures between about 14 psi (0.965 bar) and about 40 psi (2.76 bar);
cooling the beverage within the thermally conductive body to a temperature of about 45° F. or lower.
